(19) United States
(12) Patent Application Publication
(10) Pub. No.: US 2011/0078934 A1
(43) Pub. Date: Apr. 7, 2011

(54) DISPLAY ASSEMBLY HAVING DIFFERENT TYPES OF DISPLAY

(75) Inventors: Patrick McDougall, London (GB); Julian Coleman, London (GB)

(73) Assignee: NEXUS ALPHA LIMITED, London (GB)

(21) Appl. No.: 12/896,961

(22) Filed: Oct. 4, 2010

(30) Foreign Application Priority Data
Oct. 5, 2009 (GB) 0917385.7

(51) Int. Cl. G09F 13/00; G09F 7/00

(52) U.S. Cl. 40/447; 40/541; 40/584

(57) ABSTRACT

A display assembly includes a first display element which displays letters, numbers, and/or images when power is applied to it and which continues to display the letters, numbers and/or images after the power is no longer applied to it; and a second display element which only operates whilst power is applied to it. The first display element may be a cholesteric panel or a bistable nematic panel, or may use e-ink technology to display letters, numbers and/or images. The second display element may comprise one or more light sources such as LEDs.

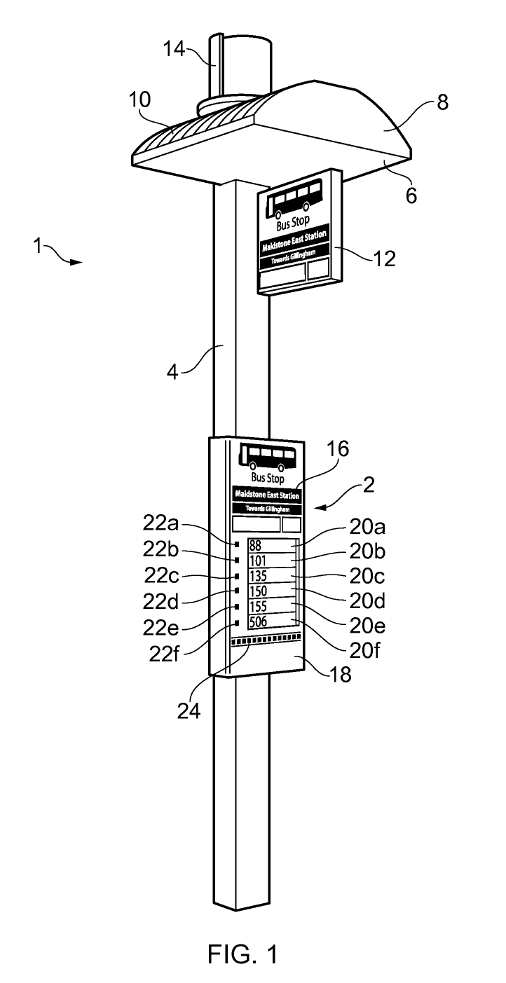

### BACKGROUND OF THE INVENTION

The invention relates to a display assembly and particularly, although not exclusively relates to a display assembly for delivering information to the public using minimal energy. One possible application is to enable the provision of travel information at locations where the provision of power by other means is not cost effective or is impractical.

In recent years the development and installation of equipment to provide passengers with up to date information on the arrival and departure of public transport services (for example, trains and buses) has resulted in such information being available at a great many locations including railway stations and at many bus stations and stops.

However the installed systems are generally fitted at locations where there is a high passenger count and where the provision of mains power is relatively easy.

For many locations where passenger numbers are lower and where power provision is more difficult it is not possible to justify the installation of such hardware as provision of power and other infrastructure means any installation would not be cost effective.

Existing information systems use technologies (typically LED and LCD) which, especially when in combination with standard computing hardware, demand too much energy to be powered by renewable sources such as wind and solar because it is not cost effective to install the panel area and battery capacity required to drive such systems.

Hence there are a great many locations where live transport information may be useful but where it is not available, and where it is highly unlikely to be available, primarily due to reasons of the cost of mains power provision.

In addition, conventional display types use considerable amounts of power and hence generate commensurate amounts of greenhouse gases.

### SUMMARY OF THE INVENTION

The present invention seeks to provide transport or other information to remote sites using signage which is designed to minimize power demand, and to reduce overall demand to a level where it can be installed at any remote location.

According to a first aspect of the present invention there is provided a display assembly comprising a first display element which displays letters, numbers and/or images when power is applied to it and which continues to display the said letters, numbers and/or images for a period after power is no longer applied to it; and a second display element which only operates whilst power is applied to it.

The said period is longer than the time taken for a conventional display element to power down. Using current technology, the said period may be at least one month and in some applications, the letters, numbers and/or images may be retained on the first display element substantially indefinitely or until such time as they are refreshed or replaced.

The first display element may, for example, be a cholesteric panel, or a bistable nematic panel. Alternatively, the first display element may use e-ink technology to display letters, numbers and/or images.

The display assembly may comprise a sign. The sign may display travel information, such as the time of arrival of buses, trams or trains. For example, the first display element may display vehicle identification information and the second display element may display the time of arrival of a vehicle.

The second display element may comprise one or more light sources such as one or more LEDs. The light sources may be aligned in a numbered row. The numbered row may comprise a “time track” which indicates when a transport service is due to arrive. Thus, the time until the service is due to arrive may be indicated by illuminating a light source next to the appropriate number. The light source may be illuminated intermittently to save power and to draw the attention of an observer. For example, the light source may flash.

The display assembly may be powered by any means available. For example, it may be powered by a solar power generator. Alternatively, or in addition, the display assembly may be powered by a wind power generator. The solar power generator and/or the wind power generator may be local to the display assembly.

The display assembly may be powered by a battery which may itself be charged by the solar power generator and/or by the wind power generator.

The display assembly may be fixed to a support post. The support post may also support the solar power and/or wind power generator.

The display assembly may comprise a processor which may be equipped with a GPRS modem. The processor may receive messages from a real time server via the modem. When messages are received, the display assembly may decode the message and change the letter(s), number(s) and/or image(s) of the first display element or update additional information which may be displayed by the display assembly.

According to another aspect of the present invention there is provided a display assembly comprising: an electronic tag reader; an information tile with an embedded electronic tag which can be read by the electronic tag reader; and a processor which controls the display configuration of the display assembly in response to the output of the electronic tag reader on reading data contained on the electronic tag.

The tag may be an active or passive electronic tag. For example, the tag may be an RFID tag.

A plurality of information tiles may be provided, each having its own electronic tag, the processor changing the display configuration of the display assembly to match whichever of the information tiles is fitted to the display assembly. In one embodiment, each information tile is provided with route information for a transport vehicle. For example, the information may be printed or stuck to the tile. The electronic tag attached to the tile or embedded in the tile may be encoded appropriately prior to deployment such that when the tile is placed on or in the display assembly, the tag reader reads the tag and provides an output to the processor causing it to output a signal which conFIGUREs the display assembly to match the information provided on the tag.

Due to its compact size, limited power demand and inherent flexibility of configuration, the invention could be used to deliver other information to site.

Further, the invention may be used to deliver such information to any site where it may be needed whether power is locally available or not as it has low power demand, and if a solar or wind power supply is provided, the invention will reduce or eliminate power demand from the grid and hence reduce or eliminate carbon dioxide generation associated with its on-going operation. Hence carbon saving benefits are gained by use of the present invention.

For a better understanding of the present invention and to show how it may be carried into effect, reference will now be made to the accompanying drawing which shows a display assembly in accordance with the present invention.

### BRIEF DESCRIPTION OF THE DRAWINGS

The sole FIGURE is a perspective view of a display assembly in accordance with the present invention.

### DETAILED DESCRIPTION OF THE PREFERRED EMBODIMENT

Referring now to the drawing, there is illustrated a display assembly 1 in accordance with the present invention comprises a sign 2 which is used to display bus numbers and estimated time of arrival of buses.

The display assembly 1 is connected to a support post 4 which may be part of, or adjacent to, a bus stop or shelter (not shown). A cantilevered roof assembly 6 projects substantially at right angles from the support post 4. An upper surface 8 of the roof assembly 6 comprises a curved solar panel 10. A storage battery, processor and associated circuitry (not shown) are contained within a hollow interior of the roof assembly 6, and additional signage 12 may be suspended from an underside of the roof assembly 6.

The support post 4 is hollow and provides a conduit for wiring which interconnects the display assembly 1 with the circuitry in the roof assembly 6. An aerial and GPRS modem (not shown) are mounted in the roof assembly 6 and are electrically connected to the circuitry and processor.

A vertical axis wind turbine 14 is fixed to the top of the support post 4. The solar panel 10 and wind turbine 14 are connected to the circuitry and charge the storage battery when they are in operation.

The display assembly 1 illustrated in the FIGURE presents information in the following three distinct ways: (1) Information which is likely to be changed infrequently is provided on the display assembly 1 by means of a series of cholesteric panels 20a, 20b, 20c, 20d, 20e and 20f; (2) Information which is likely to be changed frequently is indicated by respective light sources which may be in the form of LEDs 22a to f, each LED being situated next to a respective cholesteric panel, and by a time track 24 of LEDs which indicate the estimated time of arrival of the next service; and (3) Information which is unlikely to change during the service life of the display assembly 1 is provided on a casing 18 of the sign 2. In the embodiment illustrated in the FIGURE, the information is provided on a label 16 which is stuck to a front surface of the casing 18.

As mentioned under paragraph (1) above, information which is changed rarely, such as bus route numbers and destinations, is shown on the cholesteric panels 20a to 20f in semi permanent form. A cholesteric panel employs an LCD panel technology wherein the panels may have an image written to them and when the power is removed the image remains until the power is turned on again and a new image is written to the panel.

Whilst cholesteric LCD panels are used in the illustrated embodiment, other technologies, such as the different varieties of ‘e-ink’ and other emerging technologies such as ‘bistable nematic’ panels, may also be used.

As an alternative to electronically writeable panels it is possible to use simple plastic tiles which have an embedded RFID chip. Blank tiles may have the route information printed on (or stuck to) them and the RFID tag encoded appropriately prior to deployment. When the tile is placed into the display unit the display reads the RFID tag and configures itself accordingly.

Whatever the tile or panel technology employed, each tile or panel 20a to 20f is provided with a corresponding LED 22a to 22f which is located close to it, so that each LED is clearly associated with a respective tile or panel.

Rapidly changing information, as mentioned under paragraph (2) above, comprises two elements: a) the time until the service is due and b) any messages that are required to be relayed. The time until the service is due is shown on the time track 24 which comprises a row of LEDs which are numbered. The time until the service is due is indicated by flashing the LED next to the appropriate number. This will usually be numbered in minutes (for example 1 to 15) but may have longer periods shown by marking the ‘higher value’ LEDs with time spans such as 10-15 mins., 15-20 mins. etc.

To show the time until a service, the LED next to the service number and the relevant LED on the time track 24 are illuminated in such a way that the connection between these two elements is clear (e.g. simultaneous flashing).

When it is required to indicate the times for more than one service, each service is highlighted in turn so that a control system of the display assembly cycles through the services and their respective times. After completing each full cycle the sequence is paused and then restarted. The order and all timings may be changed as required by the circumstances.

For night time operation when it is not easy to read the panel legends, front illumination may be provided for the panels 20a to 20f. In this mode the front mounted LEDs are flashed instead of the usual LED service highlighters. In this way attention is drawn to the correct panel at the relevant time but no additional power is required.

Where technically possible, the front-lighting LEDs are cast into a clear plastic prism that also covers the front face of the panels 20a to 20f and is optically bonded to it. The prism ensures the light emitted from the LEDs is reflected towards a face of the panels 20a to 20f. This ensures that there is minimal light ‘spill’ and that the maximum amount of light is incident on the panel face which is therefore rendered more easily visible for any given power of LED, again maximizing power efficiency.

Service times are provided to the display assembly 2 via a wireless link from a central server (not shown). The server sends a signal which is picked up by the antenna, processed by the processor and control circuitry in the roof assembly 6 and converted to a current, which is relayed to the appropriate LED on the time track 24. When the service is, for example, 15 minutes away, the processor subsequently counts the number down and illuminates the appropriate LEDs in turn on the time track 24 until the service has departed, unless notified by the server that the previous prediction was incorrect. As an alternative, the processor may be programmable and so can manage non-standard messaging methods, or any combination of messaging methods.

The processor can also be used to indicate messages by illuminating one or more of any number of LEDs located next to (and visually associated with) pre-printed text in response to a signal from the server. Hence the display assembly 2 can convey complex messages whilst consuming minimal power. Whilst not as versatile as free text, this method makes it possible to indicate key messages when required. In most circumstances this will be sufficient. For example where the time to arrival is not available (for example where there may be very infrequent services during the day and consequently long gaps between services), then an LED may be used to indicate that the next service is “on its way” or alternatively “not running”.

In an alternative embodiment, the display assembly 2 is able to manage many such ‘message’ LEDs in any way which may be required. As an example, it is possible to construct a London Underground ‘Rainbow’ which indicates the service status on each of the LUL lines by illuminating one of four LEDs (which may be of different colors) to indicate whether the service on a tube line is ‘good’, has ‘minor delays’, ‘serious delays’ or is ‘suspended’.

Alternatively, the text of these ‘fixed messages’ could itself be written to a cholesteric panel or equivalent. A system of LEDs which are visually associated with each text message can then be used to highlight any applicable message as may be required.

A modified system may also support additional content associated with a service number (where the server is able to make such information available). For example if notified of the next service time when any given service is ‘cleared down’, the processor could be programmed to write that information to the relevant panel 20a to 20f. Further, in most cases the server will notify the processor of the destination of a service when the server notifies the processor of the time to arrival or departure. This destination text may also be written to the panel if desired. This enables notification of destinations which differ from the normal destination for that route. Further, it is also possible, where such information is available, to alter ‘via’ details on the panels 20 to 20f to cater for services that may take one of several routes to the same destination.

Although in the illustrated embodiment a plurality of separate panels are used to display information which changes infrequently, such as bus route numbers, in alternative embodiments only a single panel may be provided to show multiple pieces of information. For ease of reference an image on the panel may be delineated by lines which segment it. Alternatively it may be overlaid with a cover which subdivides the information on the panel.

The single panel may for example display a plurality of bus route numbers in a column with a light source such as an LED beside each bus route number.

Furthermore, the information which is changed frequently may be indicated by any display element, such as a bulb, an LED, another light source or a display panel, which only operates whilst power is applied to it.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A display assembly comprising a first display element which displays letters, numbers and/or images when power is applied to it and which continues to display the said letters, numbers and/or images after power is no longer applied to it; and
a second display element which only operates while power is applied to it.

2. A display assembly as claimed in claim 1, in which the first display element is a cholesteric panel.

3. A display assembly as claimed in claim 1, in which the first display element is a bistable nematic panel.

4. A display assembly as claimed in claim 1, in which the first display element uses e-ink technology to display letters, numbers and/or images.

5. A display assembly as claimed in claim 1 comprising a sign.

6. A display assembly as claimed in claim 5, in which the sign displays travel information.

7. A display assembly as claimed in claim 1, in which the first display element displays vehicle identification information.

8. A display assembly as claimed in claim 1, in which the second display element displays a time of arrival of a vehicle.

9. A display assembly as claimed in claim 1, in which the second display element comprises one or more light sources.

10. A display assembly as claimed in claim 9, in which the second display element comprises a plurality of light sources which are aligned in a numbered row.

11. A display assembly as claimed in claim 10, in which the numbered row of light sources comprises a time track which indicates when a transport service is due to arrive.

12. A display assembly as claimed in claim 9, in which at least one light source is illuminated intermittently.

13. A display assembly as claimed in claim 1, further comprising at least one of a solar power generator and a wind power generator.

14. A display assembly as claimed in claim 13, further comprising a support post, at least one of the solar power generator and the wind power generator being fixed to the support post.

15. A display assembly as claimed in claim 1, in which the second display element comprises one or more LEDs.

16. A display assembly as claimed in claim 1, further comprising a processor and a modem, signals received by the modem causing the processor to update the first display element and/or the second display element and/or other letters, numbers and/or images displayed by the display assembly.
